(19) United States
(12) Patent Application Publication
(10) Pub. No.: US 2025/0357596 A1
(43) Pub. Date: Nov. 20, 2025

(54) BATTERY MODULE

(71) Applicant: MURATA MANUFACTURING CO., LTD., Kyoto (JP)

(72) Inventor: Hideyasu TAKATSUJI, Kyoto (JP)

(21) Appl. No.: 19/285,051

(22) Filed: Jul. 30, 2025

Related U.S. Application Data
(63) Continuation of application No. PCT/JP2023/039894, filed on Nov. 6, 2023.

(30) Foreign Application Priority Data
Mar. 15, 2023 (JP) 2023-041179

(51) Int. Cl. H01M 50/24; H01M 10/42; H01M 10/48; H01M 50/213; H01M 50/242; H01M 50/291

(52) U.S. Cl. CPC H01M 50/24; H01M 10/425; H01M 10/482; H01M 10/486; H01M 50/213; H01M 50/242; H01M 50/291; H01M 2010/4271

(57) ABSTRACT

A battery module is provided and includes a battery; a battery holder that houses the battery and includes a cavity through which a part of the battery is exposed; a temperature sensor in contact with a part of the battery exposed from the cavity; a circuit board; a first interposed elastic member interposed between the temperature sensor and the circuit board; and a second interposed elastic member interposed between the circuit board and the battery holder and surrounding a periphery of the cavity. The first interposed elastic member is sandwiched between the circuit board and the temperature sensor, and the second interposed elastic member is sandwiched between the circuit board and the battery holder.

### CROSS REFERENCE TO RELATED APPLICATIONS

The present application is a continuation of International Application No. PCT/JP2023/039894, filed on Nov. 6, 2023, which claims priority to Japanese Patent Application No. 2023-041179, filed on Mar. 15, 2023, the entire contents of which are incorporated herein by reference.

### BACKGROUND

The present application relates to a battery module.

A known technique measures a battery temperature for a battery module including an assembled battery with a plurality of batteries as a set, and determines abnormality of the battery based on the measured battery temperature.

For example, a power supply device for a vehicle is described that includes: a plurality of batteries that are disposed vertically in multiple stages and cause a vehicle to travel; a battery holder that allows each battery to be disposed at a fixed position; and a temperature sensor that is thermally coupled to a surface of the battery and detects a temperature of the battery. The power supply device controls a current of the battery by using a battery temperature detected by the temperature sensor. The battery holder includes an electric leakage prevention cover above the temperature sensor, and the electric leakage prevention cover allows an electrolytic solution leaking from the upper-stage battery to flow to the outside of the temperature sensor.

### SUMMARY

The present application relates to a battery module.

Examples of a general method of measuring the battery temperature of the assembled battery include a method of externally applying a voltage to a temperature sensor (e.g., a thermistor) and detecting the temperature of the battery by using a change in the temperature sensor (e.g., a change in resistance value).

Here, moisture may intrude into the battery module from the outside thereof depending on the mode of use of the battery module. When the intruding moisture comes into contact with the temperature sensor, the resistance value of the temperature sensor increases due to the moisture. The increased resistance value makes it difficult to accurately measure the temperature of the assembled battery.

When the battery temperature of the assembled battery is measured, the temperature sensor is brought into contact with the assembled battery. In this case, insufficient contact therebetween also makes it difficult to accurately measure the temperature. When the lead wire extending from the temperature sensor is close to a structure other than the assembled battery (e.g., a housing that houses the assembled battery), heat exchange with the structure occurs. This also makes it difficult to accurately measure the temperature of the assembled battery.

Inan embodiment, the present disclosure relates to providing a battery module that can accurately measure a temperature of an assembled battery.

A battery module according to the present disclosure, in an embodiment, includes:
a battery;
a battery holder that houses the battery and includes a cavity through which a part of the battery is exposed;
a temperature sensor in contact with a portion of the battery exposed from the cavity;
a circuit board;
a first interposed elastic member interposed between the temperature sensor and the circuit board; and
a second interposed elastic member interposed between the circuit board and the battery holder and surrounding a periphery of the cavity.

According to the battery module of the present disclosure, in an embodiment, a temperature of the assembled battery can be accurately measured. Specifically, the first interposed elastic member interposed between the temperature sensor and the circuit board can improve close contact property between the temperature sensor and the battery. Further, the second interposed elastic member surrounding the periphery of the cavity can improve the waterproofness of the temperature sensor. As a result, the accuracy of temperature measurement by the temperature sensor can be improved.

### BRIEF DESCRIPTION OF THE FIGURES

FIG. 1A is a schematic perspective view of a battery module according to an embodiment as viewed from an upper surface side.

FIG. 1B is a schematic perspective view of the battery module according to an embodiment as viewed from a lower surface side.

FIG. 2A is a schematic perspective view of the battery module cut along line II-II in FIG. 1A as viewed from the upper surface side.

FIG. 2B is a schematic sectional view of the battery module cut along line II-II in FIG. 1A.

FIG. 2C is a schematic plan view of the battery module according to an embodiment.

FIG. 3 is an explanatory view illustrating an aspect of a liquid passing through a foam including a closed cell and an aspect of a liquid passing through a foam including an open cell.

FIG. 4A is a schematic perspective view of a battery module according to an embodiment as viewed from an upper surface side.

FIG. 4B is a schematic perspective view of the battery module according to an embodiment as viewed from a lower surface side.

FIG. 4C is a schematic bottom view of a circuit board of the battery module according to an embodiment.

FIG. 5A is an explanatory view illustrating an arrangement mode of a second interposed elastic member of the battery module according to an embodiment.

FIG. 5B is an explanatory view illustrating an arrangement mode of the second interposed elastic member of the battery module according to an embodiment.

FIG. 6A is a schematic sectional view of a battery module according to an embodiment.

FIG. 6B is a schematic sectional view of the battery module according to an embodiment.

### DETAILED DESCRIPTION

Hereinafter, a battery module according to an embodiment of the present disclosure will be described in more detail. Although the description will be made with reference to the drawings as necessary, various elements in the drawings are merely schematically and exemplarily illustrated for understanding of the present disclosure, and the appearances, the dimensional ratios, and the like may be different from those of actual ones.

Various numerical ranges referred to herein are intended to include lower limit and upper limit numerical values themselves, unless otherwise noted, such as “less than” or “greater than/larger than”. That is, when a numerical range such as 1 to 10 is taken as an example, it can be interpreted as including the lower limit of “1” and also including the upper limit of “10”. Further, terms such as “about” and “degree” mean that they may include variation of a few percent, for example, ±10%.

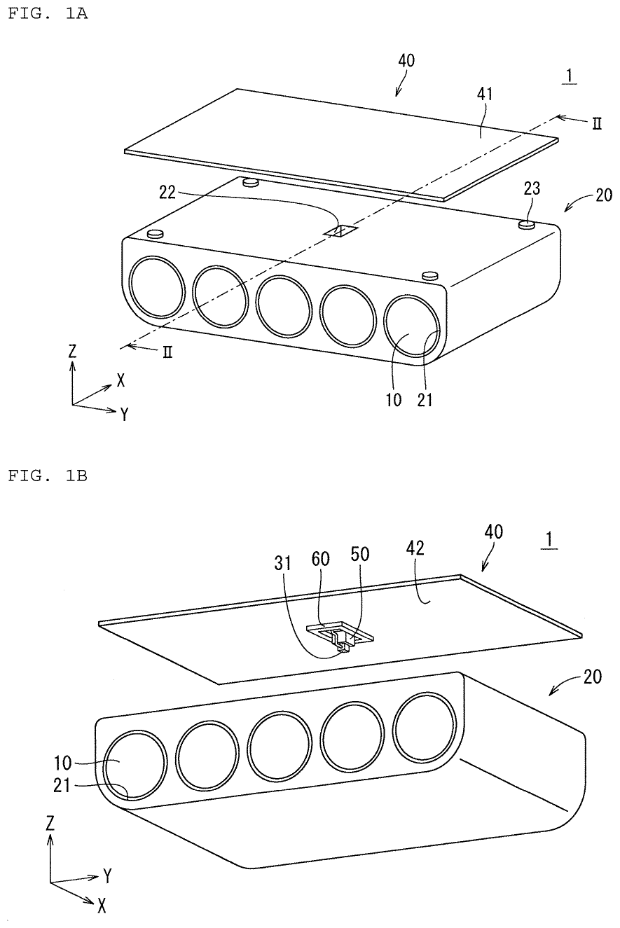

The term “planar view” used herein refers to a state when an object (e.g., a battery module) is placed and viewed from directly above its thickness (height) direction, and has the same meaning as plan view. As an example, the planar view is a state when viewed along a negative direction of a “Z-axis” illustrated in FIG. 1. The term “view from the side” used herein refers to a state when an object (e.g., a battery module) is placed and viewed from the side perpendicular to its thickness (height) direction unless otherwise specified, and has the same meaning as the side view. As an example, a view from the side is a state when viewed along a negative direction (or a positive direction) of a “Y-axis” illustrated in FIG. 1. The term “view from the front” used herein refers to a state when an object (e.g., a battery module) is placed and viewed from the front perpendicular to its thickness (height) direction unless otherwise specified, and has the same meaning as the front view. As an example, a view from the front is a state when viewed along a positive direction of an “x-axis” illustrated in FIG. 1. Note that the above-described “positive direction” is intended to be the direction of an arrow in the X-axis, the Y-axis, and the Z-axis illustrated in the drawings, and the “negative direction” is intended to be the direction opposite to the direction of the arrow in the X-axis, the Y-axis, and the Z-axis illustrated in the drawings. The X-axis, the Y-axis, and the Z-axis are orthogonal to each other.

Hereinafter, a first embodiment of a battery module 1 of the present disclosure will be described with reference to FIGS. 1 to 3. The battery module 1 of the present disclosure includes: a battery 10; a battery holder 20 that houses the battery 10 and includes a cavity 22 through which a part of the battery 10 is exposed; a temperature sensor 30 in contact with a part of the battery 10; a circuit board 40; a first interposed elastic member 50 interposed between the temperature sensor 30 and the circuit board 40; and a second interposed elastic member 60 surrounding a periphery of the cavity 22. The first interposed elastic member 50 is sandwiched between the circuit board 40 and the temperature sensor 30, and the second interposed elastic member 60 is sandwiched between the circuit board 40 and the battery holder 20. According to the battery module 1 of the present disclosure, since the first interposed elastic member 50 and the second interposed elastic member 60 are included, the waterproofness of the temperature sensor 30 and the close contact property between the temperature sensor 30 and the battery 10 can be improved. Therefore, the accuracy of temperature measurement by the temperature sensor 30 can be improved. Hereinafter, components of the first embodiment of the battery module 1 of the present disclosure will be specifically described.

The battery 10 is intended to be a chemical battery that mainly converts chemical energy into direct current power by a chemical reaction. The battery 10 used in the battery module 1 of the present embodiment is intended to be a cylindrical battery as illustrated in FIGS. 1A and 1B. The shape of the battery 10 may be a shape other than the cylindrical shape (e.g., an elliptical cylindrical shape, a rectangular columnar shape, or a polygonal columnar shape).

A metal can may be exposed on the outer peripheral surface of the battery 10 from the viewpoint that the temperature sensor 30 described later comes into contact with the outer peripheral surface and measures a resistance value. When the metal can is exposed, the battery temperature can be detected with high accuracy and less thermal resistance as compared with a case where the battery is covered with a film. Since the battery module 1 of the present disclosure includes the second interposed elastic member 60 described later, moisture is less likely to intrude into the battery module 1. Therefore, the metal can may be exposed on the outer peripheral surface of the battery 10, but the outer peripheral surface of the battery 10 excluding the portion with which the temperature sensor 30 is in contact may be covered with a film or the like.

The battery holder 20 includes a housing portion 21 that houses the battery 10. To the battery holder 20, the circuit board 40 can be attached. In the example illustrated in FIG. 1A, screw fixing portions 23 for fixing the circuit board 40 may be provided at four corners of the battery holder 20. The circuit board 40 can be fixed to the battery holder 20 via the screw fixing portions 23.

The housing portion 21 has a space for housing the battery 10. The space extends along the positive direction of the X-axis to house the battery 10. A plurality of the spaces are provided so as to be adjacent to each other along the positive direction of the Y-axis, and each space can house the battery 10. Therefore, the battery holder 20 can house the plurality of batteries 10. In the example illustrated in FIG. 1, the battery holder 20 includes five housing portions 21 along the positive direction of the Y-axis, and can house five batteries 10. The number of the housing portions 21 is not limited to five, and may be two or more.

The battery holder 20 has the cavity 22 through which a part of the battery 10 is exposed. The cavity 22 may be provided to oppose the circuit board 40 described later. More specifically, the cavity 22 allows the temperature sensor 30 and the first interposed elastic member 50 described later to enter.

The cavity 22 is preferably provided at or near the center of the battery holder 20. The term “at or near the center portion” of the battery holder 20 used herein is intended as follows. The center of the cavity 22 is located within a range of 10% of the length of the battery holder 20 in the positive direction of the Y-axis with respect to the center position of the battery holder 20 in the positive direction of the Y-axis. Further, the center of the cavity 22 is located within a range of 10% of the length of the battery holder 20 in the positive direction of the X-axis with respect to the center position of the battery holder 20 in the positive direction of the X-axis. As an example, FIG. 1 illustrates an aspect in which one cavity 22 is provided at or near the center of the battery holder 20.

The reason why the cavity is provided at or near the center of the battery holder 20 will be described. In the battery holder 20, heat is more easily accumulated to the housing portion 21 that houses the inner-side batteries 10 than the housing portion 21 that houses the outer-side batteries 10. More specifically, heat is easily accumulated in the housing portion 21 at or near the center in the positive direction of the Y-axis. Similarly, heat is likely to be accumulated at or near the center of the housing portion 21 in the positive direction of the X-axis. Accordingly, by providing the cavity 22 at or near the center portion of the battery holder 20 where heat is likely to be accumulated in the battery holder 20, it is possible to measure the temperature at a position where the temperature tends to be particularly high in the battery holder 20. Thus, the abnormality of the battery 10 can suitably be determined.

The temperature sensor 30 is in contact with a portion of the battery 10 exposed from the cavity 22 and measures the temperature of the contact portion. Examples of the temperature sensor 30 include a thermistor whose resistance value changes depending on the temperature.

As a preferred form of the temperature sensor 30, the temperature sensor 30 may include a sensor body 31 and a lead 32 electrically connected to the sensor body 31. The sensor body 31 is a structure that can cause a change in a resistance value of the sensor body 31 by bringing the sensor body 31 into contact with a temperature measurement target. The lead 32 is a structure allowing a flow of current generated from the sensor body 31 whose resistance value is changed due to the temperature of the temperature measurement target.

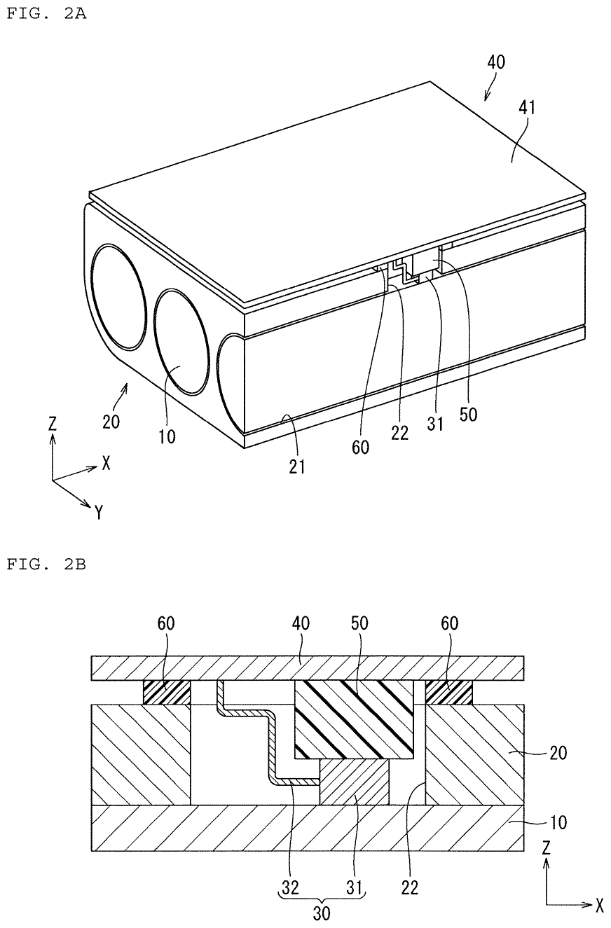

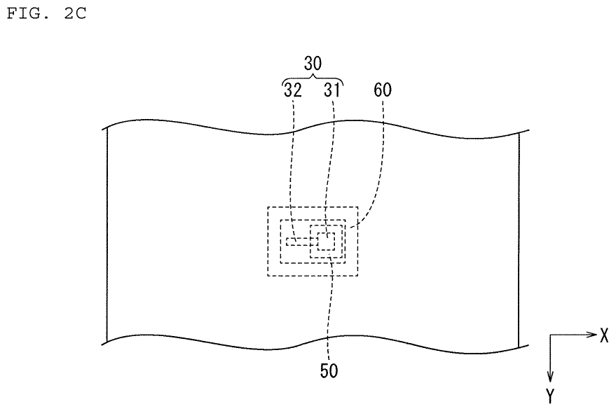

As a preferred form of the temperature sensor 30, the sensor body 31 and the lead 32 described above may be disposed at positions separated from the battery holder 20. The expression “disposed at positions separated from the battery holder” used herein is intended that the sensor body 31 and the lead 32 are in non-contact with the battery holder 20 as illustrated in FIG. 2C. More specifically, this expression is intended that a gap is provided between the sensor body 31 and the battery holder 20 and between the lead 32 and the battery holder 20. By disposing the temperature sensor 30 so as not to be in contact with the battery holder 20, the temperature sensor 30 can be prevented from detecting the temperature of the battery holder 20, and battery temperature can be measured more accurately.

The temperature sensor 30 used in the present disclosure may be a non-waterproof thermistor. In general in a waterproof thermistor, at least the sensor body 31 is subjected to coating processing or the like for imparting waterproofness. For this reason, the sensor body 31 has a large thermal resistance due to coating, and tends to have low sensor sensitivity. Therefore, to perform temperature measurement with high accuracy, it is preferable to use a non-waterproof thermistor that is not subjected to coating processing for imparting waterproofness and is less affected by thermal resistance due to coating. In the battery module of the present disclosure, moisture is less likely to enter the inside of the battery module 1 due to the second interposed elastic member 60 described in detail later. Thus, a non-waterproof thermistor having high sensor sensitivity can be adopted.

The circuit board 40 acts as a control circuit for controlling the electric power of the battery 10. The circuit board 40 includes an outer surface 41 exposed to the outside and an inner surface 42 opposing the battery holder 20. The circuit board 40 is disposed so as to cover the cavity 22 of the battery holder 20. Examples of a method of attaching the circuit board 40 to the battery holder 20 include fastening with a screw. In the example illustrated in FIG. 1A, the screw fixing portions 23 are formed at corner portions of the battery holder 20, and the circuit board 40 and the battery holder 20 are attached using the screw fixing portions 23. A method other than fastening with a screw may be used to attach the circuit board 40 and the battery holder 20.

The inner surface 42 of the circuit board 40 is provided with the first interposed elastic member 50 disposed so as to correspond to the cavity 22 of the battery holder 20, the second interposed elastic member 60 surrounding the first interposed elastic member 50, and the temperature sensor 30 disposed in a region surrounded by the second interposed elastic member 60. The sensor body 31 of the temperature sensor 30 is attached to the first interposed elastic member 50.

The first interposed elastic member 50 is interposed between the temperature sensor 30 and the circuit board 40. The first interposed elastic member 50 is sandwiched between the circuit board 40 and the temperature sensor 30. The term “interposed elastic member” used herein is intended to be a member that is deformable by an external force and is sandwiched between two structures. More specifically, the interposed elastic member used herein is intended to be interposed between the circuit board and another structure given that the elastic interposed member is provided at the circuit board.

The battery module 1 of the present disclosure includes the first interposed elastic member 50. Accordingly, when the circuit board 40 is attached to the battery holder 20, an external force is applied to the first interposed elastic member 50 in the negative direction of the Z-axis, and the first interposed elastic member 50 is compressed and deformed. With this configuration, the sensor body 31 of the temperature sensor 30 attached to the first interposed elastic member 50 can be brought into close contact with the battery 10.

As a preferred form of the first interposed elastic member 50, the first interposed elastic member 50 may include a flame-retardant resin material. More preferable examples thereof include foams of flame-retardant polypropylene (PP), polyethylene (PE), polyolefin, and polyurethane.

The foam of the first interposed elastic member 50 is preferably a foam including an open cell. The term “foam including an open cell” as used herein is intended to be a structure in which individual cells are connected to other cell(s). The first interposed elastic member 50 is preferably a so-called open cellular foam. Alternatively, as another preferred aspect, the first interposed elastic member 50 may be a so-called semi-closed and semi-open cellular foam described later. A “foam including an open cell” generally has excellent energy absorption characteristics. For this reason, when a load such as an external impact is applied to the battery module of the present disclosure, energy attributable to the external impact can be absorbed by the foam including an open cell. Therefore, the sensor body 31 of the temperature sensor 30 attached to the first interposed elastic member 50 can be protected, and the temperature measurement accuracy can be improved.

As a preferred form of the first interposed elastic member 50, the first interposed elastic member 50 may be harder than the second interposed elastic member 60. By making the first interposed elastic member 50 relatively hard, the sensor body 31 of the temperature sensor 30 can be fixed at a predetermined position.

As a more specific index of the hardness of the first interposed elastic member 50, the first interposed elastic member 50 may have a 50% compression hardness of 3 to 10 N/cm² and a 70% compression hardness of 7 to 20 N/cm². The compression hardness used herein is a value measured based on the D method in JIS K 6400-2. Specifically, the compression hardness is intended to be a load value obtained by the following procedure. The measurement target is placed flat, a circular pressurizing plate having a diameter of 200 mm is placed on the measurement target, and the measurement target is pressed by a distance so that the thickness of the pressed measurement target reaches 75% of the original thickness of the measurement target. Thereafter, the measurement target is restored to the original state, and the measurement target is pressed again by a distance so that the thickness of the pressed measurement target reaches 25% of the original thickness of the measurement target. This pressed state is kept for 20 seconds, and at this timing, the compression hardness is measured. Within the above numerical range of the compression hardness, the sensor body 31 can be more effectively brought into close contact with the battery 10, and the sensor body 31 can be more effectively fixed at a predetermined position.

In addition, the clearance (interval) between the battery holder 20 and the circuit board 40 can be adjusted by adjusting the compression hardness of the relatively hard first interposed elastic member 50 within the above range or adjusting the thickness of the first interposed elastic member 50.

The second interposed elastic member 60 surrounds the periphery of the cavity 22 provided in the battery holder 20. The second interposed elastic member 60 is sandwiched between the circuit board 40 and the battery holder 20.

In the battery module 1 of the present disclosure, when the circuit board 40 is attached to the battery holder 20, an external force is applied to the second interposed elastic member 60 in the negative direction of the Z-axis, and the second interposed elastic member 60 is compressed and deformed. Since the compressed and deformed second interposed elastic member 60 seals the periphery of the cavity 22 of the battery holder 20, moisture intrusion into the temperature sensor 30 in the cavity 22 can be prevented, and waterproofness can be improved.

As a preferred form of the second interposed elastic member 60, the second interposed elastic member 60 may include a flame-retardant resin material. More preferable examples thereof include foams of flame-retardant polypropylene (PP), polyethylene (PE), polyolefin, and polyurethane. The material of the second interposed elastic member 60 may be the same as or different from the material of the first interposed elastic member 50.

The foam of the second interposed elastic member 60 may be a foam including a closed cell, or a foam including both a closed cell and an open cell. The term “foam including a closed cell” as used herein is intended to be a structure in which individual cells are not connected to other cell(s). The term “foam including both a closed cell and an open cell” used herein is intended to be a foam including both a structure in which individual cells are not connected to other cell(s) and a structure in which individual cells are connected to other cell(s). Alternatively, a “foam including both a closed cell and an open cell” is intended to be a foam in which a plurality of cells are connected, but compression and deformation of the foam separates individual cells and allows the foam to shift to a structure close to a “foam including a closed cell”. The term “foam including both a closed cell and an open cell” as used herein has the same meaning as a so-called semi-closed and semi-open foam. The term “foam including a closed cell” as used herein has the same meaning as a so-called a closed foam.

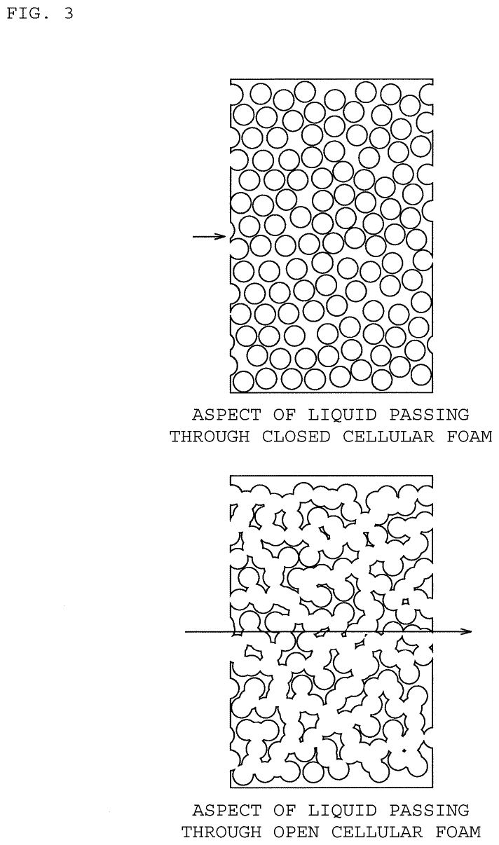

Here, how moisture intrudes into the “foam including a closed cell” and the “foam including an open cell” will be described with reference to FIG. 3. In the “foam including an open cell” illustrated in FIG. 3, individual cells are connected to other cell(s), and thus moisture travels from cell to cell. That is, the foam including an open cell has a structure in which moisture easily travels in the foam, and therefore the foam including an open cell can be said to have a structure that is less likely to prevent moisture intrusion. On the other hand, in the “foam including a closed cell” illustrated in FIG. 3, individual cells are not connected to each other, and thus moisture is less likely to travel from cell to cell. Accordingly, it can be said that the “foam including a closed cell” has a moisture-intrusion preventive structure compared to the “foam including an open cell”. Also in the semi-closed and semi-open foam described above, individual cells are separated from other cell(s) by compressing and deforming the foam, and thus the semi-closed and semi-open foam has a structure close to a “foam including a closed cell”. Therefore, it can be said that the “semi-closed and semi-open foam” has a moisture-intrusion preventive structure.

In the battery module 1 of the present disclosure, a “foam including a closed cell” or a “semi-closed and semi-open foam” is provided as the second interposed elastic member 60 around the cavity 22. This configuration can reduce moisture intrusion into the battery module 1 through the cavity 22. That is, moisture intrusion into the cavity can be suppressed by surrounding the periphery of the cavity with the closed cellular foam or the semi-closed and semi-open foam that exhibits waterproofness by being compressed.

As for the “foam” used herein, a method of discriminating a “foam including an open cell”, a “foam including a closed cell”, and a “semi-closed and semi-open foam” from each other will be described. Discrimination methods include (1) a method of checking whether water permeates the foam to reach the back surface thereof immediately after the water is dropped onto the front surface of the foam, and (2) a method of compressing and deforming the foam from the front surface and the back surface of the foam after water is dropped onto the front surface of the foam and checking whether the water permeates the foam to reach the back surface thereof. Both the discrimination methods are used to determine the type of the foam.

The “foam including an open cell” is intended to be (1) a foam that can be confirmed to allow water to immediately permeate the foam and pass therethrough to reach the back surface thereof when water is dropped onto the front surface of the foam, and (2) a foam that can be confirmed to allow water to pass therethrough to reach the back surface thereof when the foam is compressed after water is dropped onto the front surface of the foam.

The “foam including a closed cell” is intended to be (1) a foam that cannot be confirmed to allow water to pass therethrough to reach the back surface thereof when water is dropped onto the front surface of the foam, and (2) a foam that cannot be confirmed to allow water to pass therethrough to reach the back surface thereof when the foam is compressed after water is dropped onto the front surface of the foam.

The “semi-closed and semi-open foam” is intended to be a foam (1) that can be confirmed to allow water to immediately permeate the foam and pass therethrough to reach the back surface thereof when water is dropped onto the front surface of the foam, but (2) a foam that cannot be confirmed to allow water to pass therethrough to reach the back surface thereof when the foam is compressed after water is dropped onto the front surface of the foam.

In addition to these discrimination methods, discrimination may be performed by observing a section of the foam with a microscope or the like.

As a preferred form of the second interposed elastic member 60, the second interposed elastic member 60 may be softer than the first interposed elastic member 50. By making the second interposed elastic member 60 relatively soft, the second interposed elastic member 60 can be easily compressed and deformed, and the second interposed elastic member 60 can be fitted to the unevenness of the surface of the battery holder 20 and the unevenness of the surface of the circuit board 40. As a result, waterproofness can be further enhanced.

As a more specific index of the hardness of the second interposed elastic member 60, the second interposed elastic member 60 may have a 50% compression hardness of 0.2 to 1.0 N/cm² and a 70% compression hardness of 1 to 3 N/cm². The above numerical range of the compression hardness can more effectively make the second interposed elastic member 60 to be easily compressed and deformed. With the compressed and deformed second interposed elastic member 60, moisture intrusion into the battery module 1 through the cavity 22 can be reduced.

As described above, with the battery module of the present disclosure, the first interposed elastic member 50 interposed between the temperature sensor 30 and the circuit board 40 can improve close contact property between the temperature sensor 30 and the battery 10. Further, the second interposed elastic member 60 surrounding the periphery of the cavity 22 can improve the waterproofness of the temperature sensor 30. As a result, the accuracy of temperature measurement by the temperature sensor 30 can be improved.

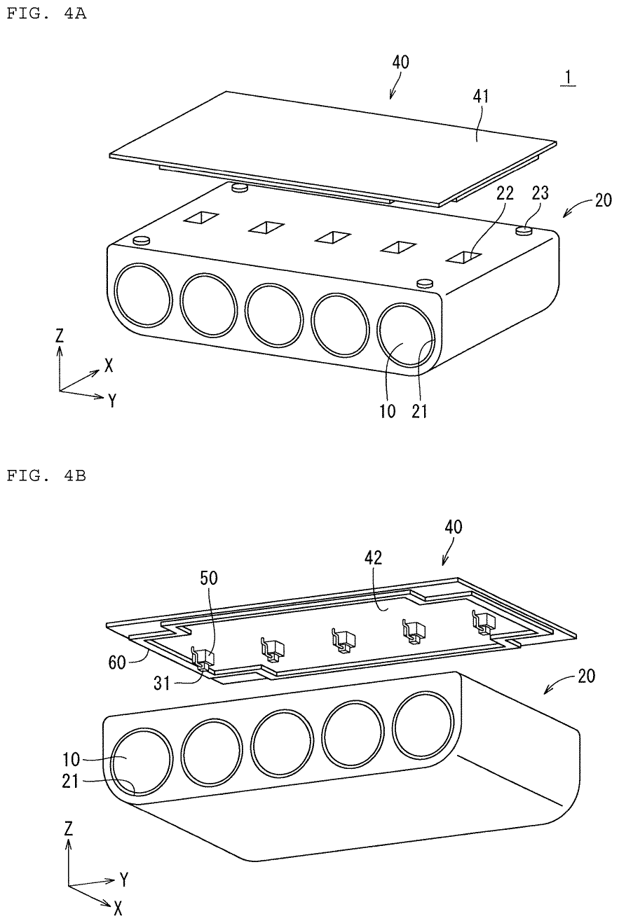

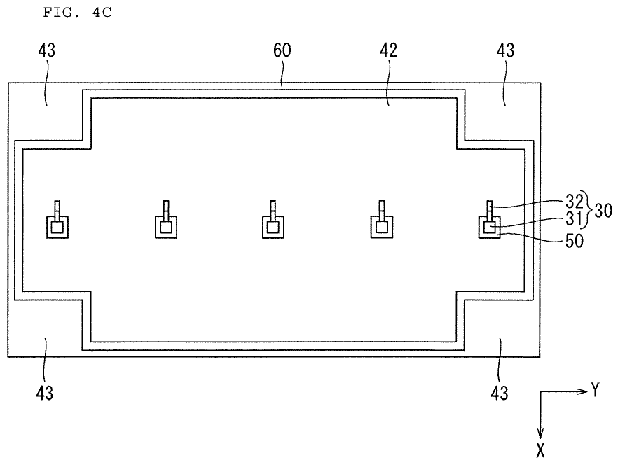

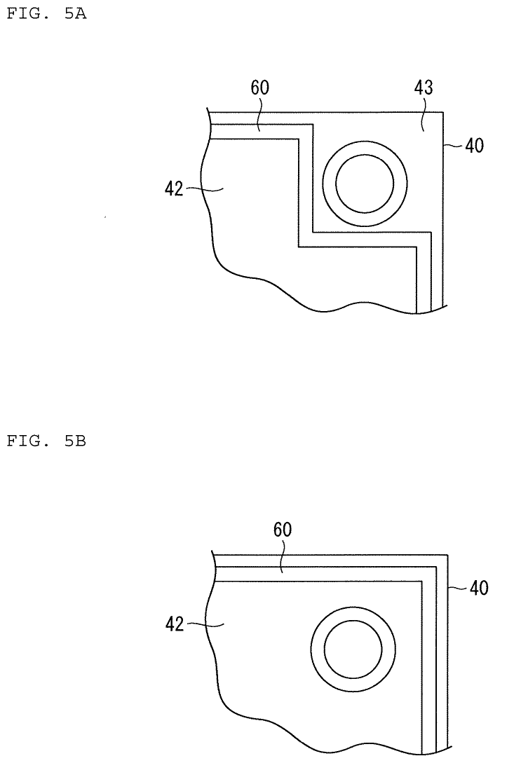

A second embodiment of the battery module of the present disclosure will be described with reference to FIGS. 4 and 5. The second embodiment is different from the above-described embodiment in the configuration of a second interposed elastic member 60 and the configuration of a cavity 22. Other configurations are basically the same as those of the above-described embodiment. Hereinafter, this different configuration will be described.

A battery holder 20 of the second embodiment houses a plurality of batteries 10 and includes a plurality of the cavities 22 through each of which a part of a respective one of the batteries 10 is exposed. In the example illustrated in FIG. 4A, five cavities 22 are provided corresponding to all five housing portions 21. That is, the five cavities 22 are provided so as to be adjacent to each other along the direction in which the batteries 10 are disposed (positive direction of the Y-axis).

An inner surface 42 of a circuit board 40 of the second embodiment is provided with a first interposed elastic member 50 provided so as to correspond to the plurality of cavities 22 of the battery holder 20, a second interposed elastic member 60 surrounding all of the first interposed elastic members 50, and a plurality of temperature sensors 30 provided so as to correspond to the respective first interposed elastic members 50. Sensor bodies 31 of the temperature sensors 30 are respectively attached to the first interposed elastic members 50.

The first interposed elastic members 50 of the second embodiment are provided so as to correspond to the plurality of cavities 22 of the battery holder 20. More specifically, the first interposed elastic members 50 are provided along a direction in which the batteries 10 are disposed corresponding to the plurality of cavities 22 (positive direction of the Y-axis). In the example illustrated in FIG. 4B, the five cavities 22 are provided corresponding to all of the five housing portions 21. The sensor body 31 of the temperature sensor 30 described above is attached to each of the first interposed elastic members 50.

The second interposed elastic member 60 of the second embodiment includes fastening regions 43 for screw fastening at positions corresponding to the four corners of the circuit board 40. In other words, the second interposed elastic member 60 has a frame shape including the fastening regions 43 at the four corners as illustrated in FIG. 4C. The term “frame shape” used herein is intended to be a shape of a frame surrounding at least all of the cavities 22 of the battery holder 20.

Here, the fastening region 43 of the present embodiment will be described in detail with reference to FIGS. 5A and 5B. As illustrated in FIG. 5B, if no fastening region is provided in the circuit board 40, and screw fastening is performed inside the second interposed elastic member 60 (i.e., inside the frame), the second interposed elastic member 60 receives a stress at the time of screw fastening. The reduction of the stress at the time of screw fastening requires the increase in the sizes of the circuit board 40 and the battery holder 20. However, in the present embodiment, as illustrated in FIG. 5A, the circuit board 40 and the battery holder 20 can be fastened with a screw by utilizing the fastening region 43 provided outside the second interposed elastic member 60 (i.e., outside the frame). Therefore, the circuit board 40 and the battery holder 20 can be downsized as compared with the example illustrated in FIG. 5B.

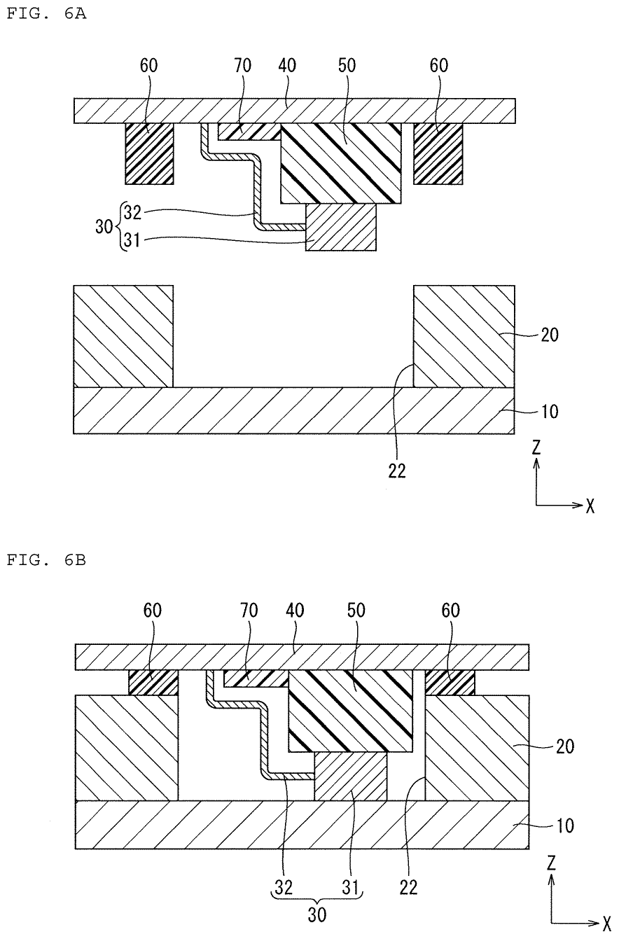

A third embodiment of the battery module of the present disclosure will be described with reference to FIGS. 6A and 6B. The third embodiment is different from the above-described embodiments in that the battery module includes a third interposed elastic member 70. Other configurations are basically the same as those of the above-described embodiments. Hereinafter, this different configuration will be described.

A battery module 1 of the third embodiment includes the third interposed elastic member 70 that is interposed between a lead 32 and a circuit board 40 and separates the circuit board 40 from a portion of the lead 32 other than a connection portion with the circuit board 40. The expression “separates the circuit board 40 from a portion of the lead 32 other than a connection portion with the circuit board 40” used herein is intended that the lead 32 is in non-contact with the circuit board 40 at a portion excluding the end portion of the lead 32 in contact with the circuit board 40.

The third interposed elastic member 70 may include a heat insulating material to reduce heat conduction to the lead 32. That is, a resin material having a low thermal conductivity may be used. For example, as in a first interposed elastic member 50 and a second interposed elastic member 60, a foam of flame-retardant polypropylene (PP), polyethylene (PE), polyolefin, or polyurethane may be used. Note that a heat-insulating resin other than the above materials may be used. A material different from those of the first interposed elastic member 50 and the second interposed elastic member 60 may also be used.

The third interposed elastic member 70 may be disposed in a region between the first interposed elastic member 50 and the second interposed elastic member 60. The third interposed elastic member 70 may be provided on the side in which the lead 32 of a temperature sensor 30 extends with respect to the first interposed elastic member 50. Specifically, in the examples of FIGS. 6A and 6B, the third interposed elastic member 70 may be provided on the X-axis (negative direction) side with respect to the first interposed elastic member.

According to the battery module 1 of the third embodiment, the third interposed elastic member 70 is interposed between the lead 32 and the circuit board 40, and the circuit board 40 is separated from the portion of the lead 32 other than the connection portion with the circuit board 40. Thus, the temperature is relatively lower than the battery temperature as the heating element. This can further reduce transfer of heat from the circuit board 40 or a battery holder 20 having a large heat capacity and heat conduction to the temperature sensor 30. Accordingly, the battery temperature can be measured more accurately. In the present embodiment, the first interposed elastic member 50 and the third interposed elastic member 70 are described as separate members, but the first interposed elastic member 50 may also serve as the function and configuration of the third interposed elastic member 70.

It should be noted that embodiments disclosed herein are by way of illustration in all respects and not a basis for a restrictive interpretation. Therefore, the technical scope of the present disclosure is not to be construed only by the above-described embodiments, but is defined based on the recitation of the claims. In addition, the technical scope of the present disclosure encompasses meanings equivalent to the claims and all modifications within the scope.

The battery module of the present disclosure includes the following aspects according to an embodiment.

<1> A battery module including:
a battery;
a battery holder that houses the battery and includes a cavity through which a part of the battery is exposed;
a temperature sensor in contact with a portion of the battery exposed from the cavity;
a circuit board;
a first interposed elastic member interposed between the temperature sensor and the circuit board; and
a second interposed elastic member interposed between the circuit board and the battery holder and surrounding a periphery of the cavity.

<2> The battery module according to <1>, in which the first interposed elastic member is a foam including an open cell.

<3> The battery module according to <1> or <2>, in which the first interposed elastic member is sandwiched between the circuit board and the temperature sensor.

<4> The battery module according to any one of <1> to <3>, in which the second interposed elastic member is sandwiched between the circuit board and the battery holder.

<5> The battery module according to any one of <1> to <4>, in which the second interposed elastic member is a foam including a closed cell, or a foam including both a closed cell and an open cell.

<6> The battery module according to any one of <1> to <5>, in which the first interposed elastic member is harder than the second interposed elastic member.

<7> The battery module according to <6>, in which
the first interposed elastic member has a 50% compression hardness of 3 to 10 N/cm² and a 70% compression hardness of 7 to 20 N/cm², and
the second interposed elastic member has a 50% compression hardness of 0.2 to 1.0 N/cm² and a 70% compression hardness of 1 to 3 N/cm².

<8> The battery module according to any one of claims <1> to <7>, in which
the temperature sensor includes a sensor body, and a lead that connects the sensor body and the circuit board, and
the sensor body and the lead are disposed at positions separated from the battery holder.

<9> The battery module according to <8>, further including a third interposed elastic member that is interposed between the lead and the circuit board, and separates the circuit board from a portion of the lead other than a connection portion with the circuit board.

<10> A battery module including:
a plurality of batteries;
a plurality of temperature sensors, each of which is in contact with a part of a respective one of the plurality of batteries;
a circuit board;
a battery holder that houses the plurality of batteries and includes a plurality of cavities through each of which a part of a respective one of the plurality of batteries is exposed;
a plurality of first interposed elastic members, each of which pressurizes a respective one of the plurality of temperature sensors; and
a second interposed elastic member that is provided surrounding all of the plurality of cavities and suppresses water intrusion into all of the plurality of cavities, in which
each of the plurality of first interposed elastic members is sandwiched between the circuit board and a respective one of the plurality of temperature sensors, and
the second interposed elastic member is sandwiched between the circuit board and the battery holder.

The present disclosure can be used for a battery module that can accurately measure a temperature of an assembled battery.

### DESCRIPTION OF REFERENCE SYMBOLS

1: Battery module
10: Battery
20: Battery holder
21: Housing portion
22: Cavity
23: Screw fixing portion
30: Temperature sensor
31: Sensor body
32: Lead
40: Circuit board
41: Outer surface
42: Inner surface
43: Fastening region
50: First interposed elastic member
60: Second interposed elastic member
70: Third interposed elastic member

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery module comprising:
a battery;
a battery holder that houses the battery and includes a cavity through which a part of the battery is exposed;
a temperature sensor in contact with a portion of the battery exposed from the cavity;
a circuit board;
a first interposed elastic member interposed between the temperature sensor and the circuit board; and
a second interposed elastic member interposed between the circuit board and the battery holder and surrounding a periphery of the cavity.

2. The battery module according to claim 1, wherein the first interposed elastic member is a foam including an open cell.

3. The battery module according to claim 1, wherein the first interposed elastic member is sandwiched between the circuit board and the temperature sensor.

4. The battery module according to claim 1, wherein the second interposed elastic member is sandwiched between the circuit board and the battery holder.

5. The battery module according to claim 1, wherein the second interposed elastic member is a foam including a closed cell, or a foam including both a closed cell and an open cell.

6. The battery module according to claim 1, wherein the first interposed elastic member is harder than the second interposed elastic member.

7. The battery module according to claim 6, wherein
the first interposed elastic member has a 50% compression hardness of 3 to 10 N/cm² and a 70% compression hardness of 7 to 20 N/cm², and
the second interposed elastic member has a 50% compression hardness of 0.2 to 1.0 N/cm² and a 70% compression hardness of 1 to 3 N/cm².

8. The battery module according to claim 1, wherein
the temperature sensor includes a sensor body, and a lead that connects the sensor body and the circuit board, and
the sensor body and the lead are disposed at positions separated from the battery holder.

9. The battery module according to claim 8, further comprising a third interposed elastic member that is interposed between the lead and the circuit board, and separates the circuit board from a portion of the lead other than a connection portion with the circuit board.

10. A battery module comprising:
a plurality of batteries;
a plurality of temperature sensors, each of which is in contact with a part of a respective one of the plurality of batteries;
a circuit board;
a battery holder that houses the plurality of batteries and includes a plurality of cavities through each of which a part of a respective one of the plurality of batteries is exposed;
a plurality of first interposed elastic members, each of which pressurizes a respective one of the plurality of temperature sensors; and
a second interposed elastic member that is provided surrounding all of the plurality of cavities and suppresses water intrusion into all of the plurality of cavities, wherein
each of the plurality of first interposed elastic members is sandwiched between the circuit board and a respective one of the plurality of temperature sensors, and
the second interposed elastic member is sandwiched between the circuit board and the battery holder.
